(19) United States
(12) Patent Application Publication
(10) Pub. No.: US 2012/0038617 A1
(43) Pub. Date: Feb. 16, 2012

(54) ORGANIC LIGHT EMITTING DISPLAY DEVICE AND METHOD OF DRIVING THE SAME

(76) Inventors: Bo-Yong Chung, Yongin-city (KR); Deok-Young Choi, Yongin-city (KR)

(21) Appl. No.: 13/154,177

(22) Filed: Jun. 6, 2011

(30) Foreign Application Priority Data
Aug. 10, 2010 (KR) 10-2010-0076854

(51) Int. Cl. G06F 3/038

(52) U.S. Cl. 345/212; 345/211

(57) ABSTRACT

There is provided an organic light emitting display device including: pixels positioned at crossing regions of scan lines and data lines; a first control line and a second control line commonly coupled to the pixels; and a control line driver for supplying a first control signal to the first control line for a reset period and for supplying a second control signal to the second control line for a compensation period, wherein each of the pixels includes: an organic light emitting diode; a first transistor for controlling an amount of current supplied from a first power source to a second power source; a second transistor configured to turn on when the second control signal is supplied; and a fourth transistor for supplying an initial voltage to a gate electrode of the first transistor when the first control signal is supplied.

### CROSS-REFERENCE TO RELATED APPLICATION

This application claims priority to and the benefit of Korean Patent Application No. 10-2010-0076854, filed on Aug. 10, 2010, in the Korean Intellectual Property Office, the entire content of which is incorporated herein by reference.

### BACKGROUND

1. Field

Embodiments of the present invention relate to an organic light emitting display device and a method of driving the same, and more particularly, to an organic light emitting display driven by a concurrent (e.g., simultaneous) emission method with active voltage and a method of driving the same.

2. Description of the Related Art

Recently, various flat panel displays (FPDs) have been developed which have the advantages of reduced weight and volume relative to cathode ray tubes (CRTs). Various FPDs include liquid crystal displays (LCDs), field emission displays (FEDs), plasma display panels (PDPs), and organic light emitting displays.

Among the FPDs, the organic light emitting display displays an image using organic light emitting diodes (OLEDs) that generate light by recombining electrons and holes. Organic light emitting displays have advantages of high response speeds and are driven using low power consumption.

The organic light emitting display includes pixels positioned at crossing regions between data lines, scan lines, and power lines arranged in a matrix form. In general, each of the pixels includes an organic light emitting diode, two or more transistors including a driving transistor, and at least one capacitor.

An organic light emitting display device is generally driven by a progressive emission method. The progressive emission means a method in which data are sequentially input in accordance with scan signals provided on respective scan lines, and pixels sequentially emit light by horizontal lines in an order that is the same as the data input order of data.

However, in driving an organic light emitting display device by the progressive emission, crosstalk may occur when a 3D image is displayed. In order to solve this problem, a method of adding non-emissive regions between frames has been proposed but emission time is decreased.

### SUMMARY

Accordingly, embodiments according to the present invention provide an organic light emitting display driven by a concurrent (e.g., simultaneous) emission method and a method of driving the same.

Embodiments of the present invention also provide an organic light emitting display device driven by a concurrent (e.g., simultaneous) emission method without a voltage of power sources (a first power source and a second power source) and a method of driving the same.

In order to achieve the foregoing aspects, according to an embodiment of the present invention, there is provided an organic light emitting display having a frame period comprising a reset period, a compensation period, a data period, and an emission period, the organic light emitting display device including: pixels positioned at crossing regions between scan lines and data lines; a first control line and a second control line commonly coupled to the pixels; and a control line driver for supplying a first control signal to the first control line for the reset period, and for supplying a second control signal to the second control line for the compensation period.

Each of the pixels include: an organic light emitting diode; a first transistor having a first electrode, a second electrode, and a gate electrode, the first transistor configured to control the amount of current supplied from a first power source coupled to the first electrode to a second power source via the organic light emitting diode; a second transistor coupled between the gate electrode of the first transistor and the second electrode of the first transistor and configured to turn on when the second control signal is supplied; and a fourth transistor coupled to the gate electrode of the first transistor and configured to supply an initial voltage to the gate electrode of the first transistor when the first control signal is supplied.

The pixels may be set to a non-emission state for the reset period, the compensation period, and the data period.

The organic light emitting display device may further include: a scan driver configured to concurrently supply a first scan signal to the scan lines for the reset period and the compensation period and to sequentially supply a second scan signal to the scan lines for the data period; and a data driver configured to supply a data signal to the data lines in synchronization with the second scan signal during the data period.

Additionally, the organic light emitting display device may further include an emission control line commonly coupled to the pixels.

The control line driver may be configured to supply an emission control signal to the emission control line for the reset period, the compensation period, and the data period.

Each of the pixels may include: a first capacitor coupled between the gate electrode of the first transistor and a second node; a third transistor coupled between the data lines and the second node and configured to be turned on when a first scan signal and a second scan signal are supplied to the scan lines; a second capacitor coupled between the second node and the first power source; and a fifth transistor coupled between the second electrode of the first transistor and the organic light emitting diode, the fifth transistor being configured to be turned off when an emission control signal is supplied to the emission control line, and to be turned on otherwise.

Each of the pixels may include: a first capacitor coupled between the gate electrode of the first transistor and the data lines; a third transistor coupled between the first capacitor and the data lines and configured to be turned on when a first scan signal and a second scan signal are supplied to the scan lines; a second capacitor coupled between the gate electrode of the first transistor and the first power source; and a fifth transistor coupled between the second electrode of the first transistor and the organic light emitting diode, the fifth transistor being configured to be turned off when an emission control signal is supplied to the emission control line, and turned on otherwise.

The data driver may be configured to supply a voltage of a reference power source to the data lines for the reset period, the compensation period, and the emission period.

A voltage of the reference power source may be a voltage within a voltage range of the data signals.

The organic light emitting display device may further include a switching device coupled between each of the data lines and the reference power source and turned on for the reset period, the compensation period, and the emission period.

The voltage of the reference power source may be a voltage within a voltage range of the data signals.

The initial voltage may be set to a voltage lower than the first power source.

The fourth transistor may be configured to supply a voltage applied to an anode electrode of the organic light emitting diode as the initial voltage.

The fourth transistor may be configured to supply a voltage of the second power source as the initial voltage.

The fourth transistor may be electrically coupled to an initial power source for supplying the initial voltage.

A second embodiment of the present invention provides a method of driving an organic light emitting display device having a frame period comprising a reset period, a compensation period, a data period, and an emission period, the method includes: initializing gate electrodes of driving transistors included in respective pixels to an initial voltage for the reset period; charging first capacitors of the respective pixels to a voltage corresponding to a threshold voltage of the driving transistors for the compensation period while diode-connecting the driving transistors; charging second capacitors of the respective pixels to a voltage corresponding to data signals by supplying the data signals to the pixels for the data period; and controlling an amount of current supplied from a first power source to an organic light emitting diode in response to a voltage applied to gate electrodes of the driving transistors for the emission period.

The initial voltage may be set to a voltage lower than a voltage of the first power source.

The pixels may be set to a non-emission state for the reset period, the compensation period, and the data period.

Accordingly, aspects of the embodiments of the present invention provide an organic light emitting display device driven by the concurrent (e.g., simultaneous) emission method without change of a voltage of a power source and the method of driving the same. Additionally, according to another aspect of the embodiments of the present invention, an image of desired brightness may be displayed regardless of changes of the first power source and the second power source and variations in the threshold voltage of the driving transistors.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a view illustrating one frame period according to an embodiment of the present invention;

FIG. 2 is a view illustrating an example of implementing a shutter glasses based 3D display by progressive emission;

FIG. 3 is a view illustrating an example of implementing shutter glasses based 3D display by a concurrent (e.g., simultaneous) emission method according to an embodiment of the present invention;

FIG. 4 is a view illustrating an organic light emitting display device according to an embodiment of the present invention;

FIG. 5 is a view illustrating a first embodiment of a pixel of FIG. 4;

FIG. 6 is a waveform chart illustrating a method of driving the pixel of FIG. 5;

FIG. 7 is a view illustrating a second embodiment of the pixel of FIG. 4;

FIG. 8 is a view illustrating a third embodiment of the pixel of FIG. 4;

FIG. 9 is a view illustrating a fourth embodiment of the pixel of FIG. 4;

FIG. 10 is a view illustrating a fifth embodiment of the pixel of FIG. 4;

FIG. 11 is a view illustrating a sixth embodiment of the pixel of FIG. 4;

FIG. 12 is a view illustrating an organic light emitting display device according to another embodiment of the present invention;

FIG. 13 is a graph illustrating current corresponding to a data voltage in a pixel according to a third embodiment of the present invention;

FIG. 14 is a graph illustrating change of current corresponding to voltage drop of a first power source in the pixel according to the third embodiment of the present invention;

FIG. 15 is a graph illustrating change of current corresponding to change of a voltage of a second power source in the pixel according to the third embodiment of the present invention; and

FIG. 16 is a graph illustrating change of current corresponding to change of a threshold voltage of a first transistor in the pixel according to the third embodiment of the present invention.

### DETAILED DESCRIPTION OF THE EMBODIMENTS

Hereinafter, certain exemplary embodiments according to the present invention will be described with reference to the accompanying drawings. Here, when a first element is described as being coupled to a second element, the first element may be directly coupled to the second element, or may be indirectly coupled to the second element via a third element. Further, some of the elements that are not essential for a complete understanding of the invention are omitted for clarity. Also, like reference numerals refer to like elements throughout.

Hereinafter, exemplary embodiments of the present invention will be described in detail with reference to FIGS. 1 to 16.

FIG. 1 is a view illustrating one frame period according to an embodiment of the present invention.

Referring to FIG. 1, one frame 1F according to an embodiment of the present invention is divided into a reset period RP, a compensation period CT, a data period DP, and an emission period EP.

An initial voltage is supplied to gate electrodes of driving transistors of all pixels for the reset period RP. Here, the initial voltage is a voltage lower than a first power source ELVDD, and any one of various voltages applied to the pixels is selected as the initial voltage.

Threshold voltages of the driving transistors of the respective pixels are compensated for during the compensation period CP. The respective pixels charge voltages corresponding to the threshold voltages of the driving transistors for the compensation period CP.

The pixels are selected by a horizontal line (i.e., selected line-by-line) for the data period DP, and data signals are supplied to the selected pixels. The respective pixels charge voltages corresponding to the data signals for the data period DP. Meanwhile, the pixels are set in non-emission state for the reset period RP, the compensation period CP, and the data period DP.

The pixels generate light (e.g., of desired brightness) for the emission period EP. Here, since the threshold voltages of the driving transistors are compensated for the compensation period CP, a uniform image is displayed regardless of variations of the threshold voltages of the driving transistors for the emission period EP.

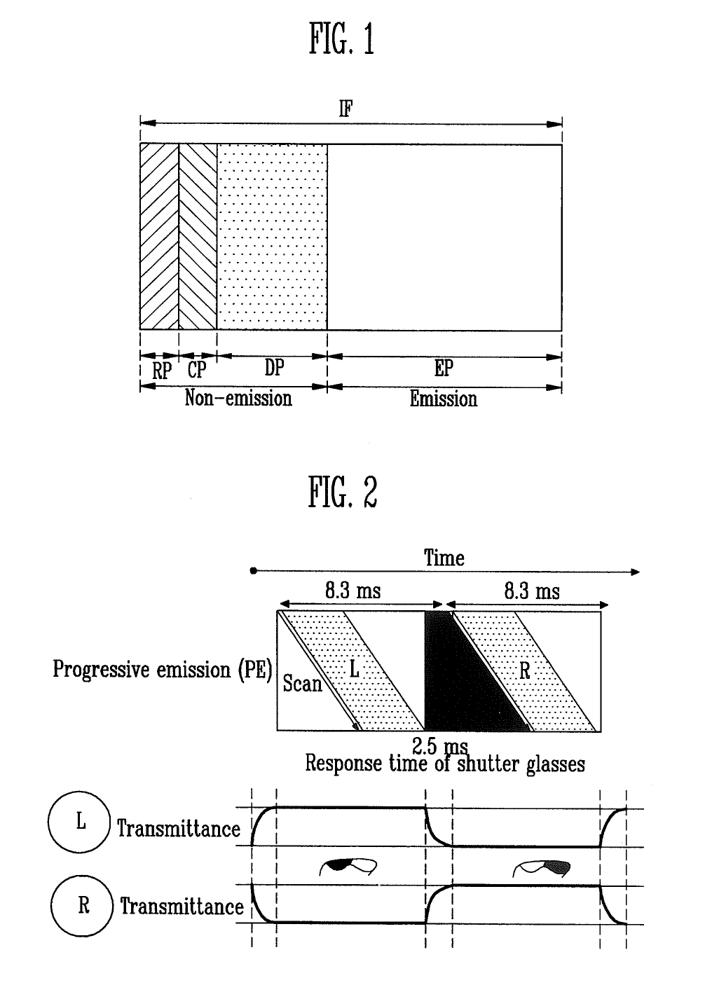

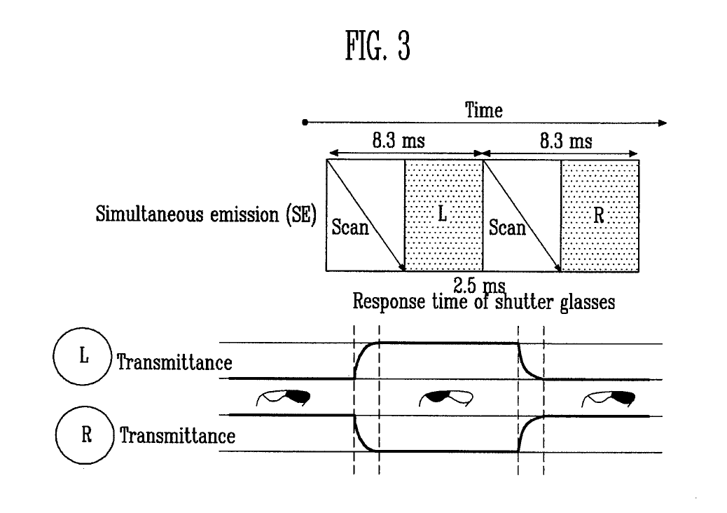

FIG. 2 is a view illustrating an example of implementing a shutter glasses based 3D display by a progressive emission method.

Referring to FIG. 2, in a case where a screen is output in a progressive emission method, in order to prevent or reduce crosstalk between a left eye image and right a eye image, emission must be stopped by a response time (e.g., 2.5 ms) of shutter glasses. An emission region is generated by a response time of the shutter glasses between a frame (e.g., an ith frame, herein i is a natural number) of outputting a left eye image and a frame (e.g., (i+1)th frame) of outputting a right eye image, and a duty ratio is lowered.

FIG. 3 is a view illustrating an example of implementing a shutter glasses based 3D display by a concurrent (e.g., simultaneous) emission method according to an embodiment of the present invention.

Referring to FIG. 3, a display unit emits light when outputting a display by the concurrent emission, and the pixels are set to a non-emission state for periods other than the emission period. Therefore, the non-emission period may be naturally secured between the period of outputting a left eye image and the period of outputting a right eye image.

The reset period RP, the compensation period CP, and the data period DP are set to the non-emission state between the ith frame and the (i+1) th frame. When this period is synchronized with a response time of the shutter glasses, the duty ratio does not need to be decreased, which is different from the progressive emission method.

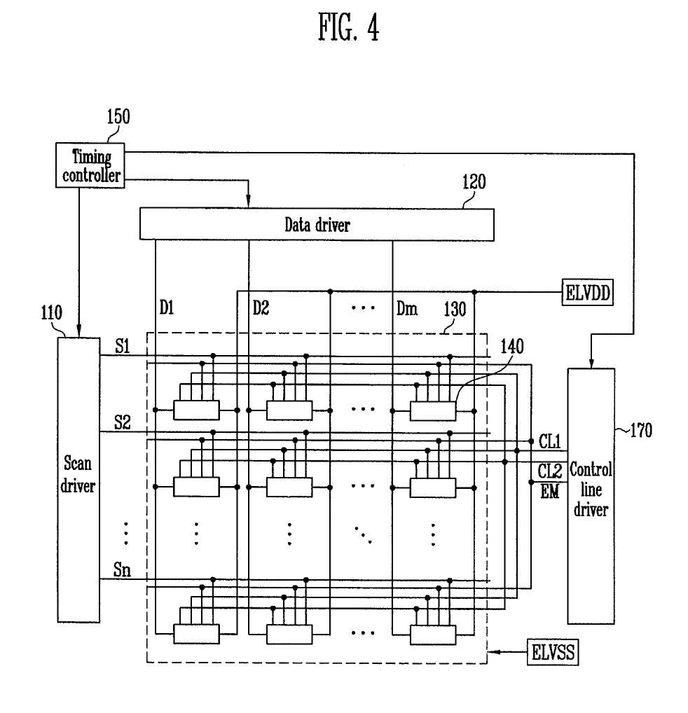

FIG. 4 is a view illustrating an organic light emitting display device according to an embodiment of the present invention.

Referring to FIG. 4, the organic light emitting display according to the embodiment of the present invention includes a display unit 130 including pixels 140 positioned to be coupled to scan lines S1 to Sn and data lines D1 to Dm, a scan driver 110 for driving the scan lines S1 to Sn, a data driver 120 for driving the data lines D1 to Dm, a control line driver 170 for driving an emission control line EM, a first control line CL1, and a second control line CL2, and a timing controller 150 for controlling the scan driver 110, the data driver 120, and the control line driver 170.

The scan driver 110 concurrently (e.g., simultaneously) supplies the generated scan signals (or a first scan signal) to the scan lines S1 to Sn for the reset period RP and the compensation period CP. The scan driver 110 sequentially supplies the scan signals (or a second scan signal) to the scan lines S1 to Sn for the data period DP.

The data driver 120 supplies a voltage of a reference power source Vref to the data lines D1 to Dm for the reset period RP, the compensation period CP, and the emission period EP, and supplies the data signal to be synchronized with the scan signal to the data lines D1 to Dm for the data period DP. Here, the voltage of the reference power source Vref is set to a specific voltage within a range of voltages of the data signals.

The control line driver 170 supplies a first control signal to the first control line CL1 for the reset period RP and supplies a second control signal to a second control line CL2 for the compensation period CP. The control line driver 170 supplies an emission control signal to the emission control line EM for the reset period RP, the compensation period CP, and the data period DP. The emission control line EM is commonly coupled to the pixels 140, and the pixels 140 are set to the non-emission state for the reset period RP, the compensation period CP, and the data period DP when the emission control signal is supplied.

The timing controller 150 controls the scan driver 110, the data driver 120, and the control line driver 170 in response to synchronization signals (e.g., synchronization signals supplied from an external source).

The display unit 130 receives voltage from a first power source ELVDD and a second power source ELVSS, e.g., from external sources, and supplies the power source voltages to the pixels 140. Each of the pixels 140 charges a voltage corresponding to the threshold voltage of the respective driving transistor in the pixel for the compensation period CP, and charges a voltage corresponding to a respective data signal for the data period DP. During the emission period EP, pixels 140 generate light corresponding to the respective charged voltages corresponding to the respective data signals.

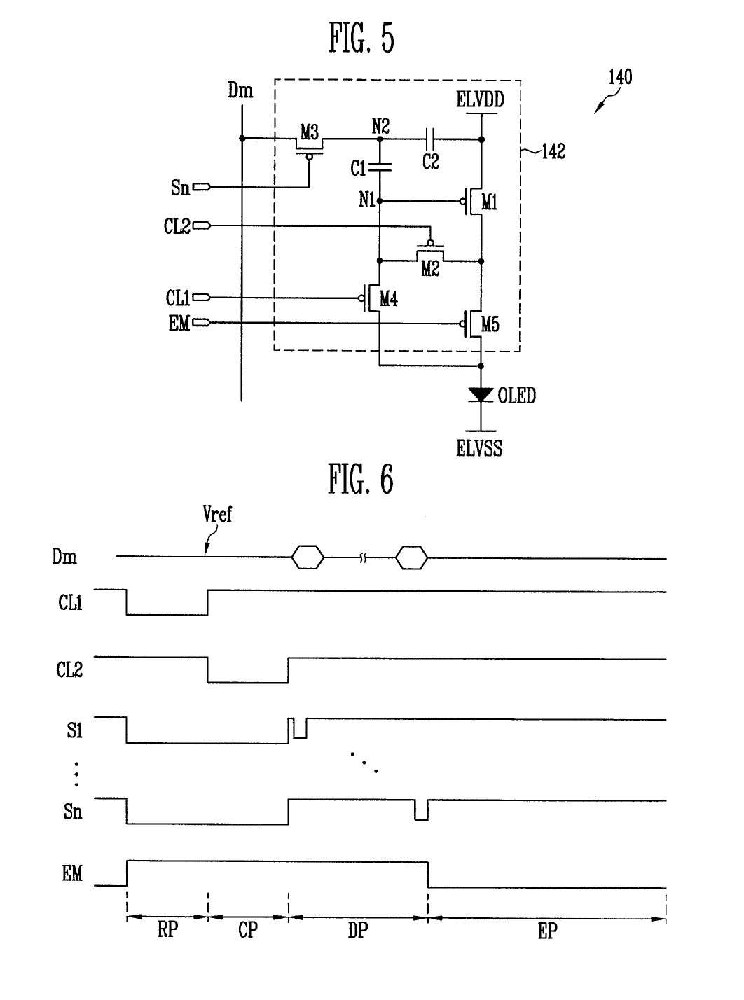

FIG. 5 is a view illustrating a pixel according to a first embodiment of the present invention. For illustration purpose, FIG. 5 shows a pixel coupled to an nth scan line Sn and an mth data line Dm.

Referring to FIG. 5, the pixel 140 according to the first embodiment of the present invention includes an OLED and a pixel circuit 142 for controlling the amount of current supplied to the OLED.

An anode electrode of the OLED is coupled to the pixel circuit 142 and a cathode electrode of the OLED is coupled to the second power source ELVSS. The OLED generates light (e.g., with predetermined brightness) in response to (e.g., in accordance with) the current supplied from the pixel circuit 142.

The pixel circuit 142 includes a first transistor M1 to a fifth transistor M5, a first capacitor C1, and a second capacitor C2.

A gate electrode of the first transistor M1 is coupled to a first node N1 and a first electrode of the first transistor M1 is coupled to the first power source ELVDD. A second electrode of the first transistor M1 is coupled to a first electrode of the fifth transistor M5. The first transistor M1 controls the amount of current supplied from the first power source ELVDD to the second power source ELVSS via the OLED in response (e.g., in accordance with) a voltage applied to the first node N1.

A first electrode of the second transistor M2 is coupled to a second electrode of the first transistor M1, and a second electrode of the second transistor M2 is coupled to the first node N1. A gate electrode of the second transistor M2 is coupled to the second control line CL2. The second transistor M2 is turned on when a second control signal is supplied to the second control line CL2 and electrically couples the gate electrode to the second electrode of the first transistor M1. In this case, the first transistor M1 is coupled in the form of a diode.

A first electrode of the third transistor M3 is coupled to the data line Dm and a second electrode of the third transistor M3 is coupled to the second node N2. A gate electrode of the third transistor M3 is coupled to the scan line Sn. The third transistor M2 is turned on when the scan signal is supplied to the scan line Sn, and electrically couples the data line Dm to the second node N2.

A first electrode of the fourth transistor M4 is coupled to the first node N1 and a second electrode of the fourth transistor M4 is coupled to an anode electrode of the OLED. A gate electrode of the fourth transistor M4 is coupled to the first control line CL1. The fourth transistor M4 is turned on when the first control signal is supplied to the first control line CL1, and couples the first node N1 to the anode electrode of the OLED.

A first electrode of the fifth transistor M5 is coupled to the second electrode of the first transistor M1 and a second electrode of the fifth transistor M5 is coupled to the anode electrode of the OLED. A gate electrode of the fifth transistor M5 is coupled to the emission control line EM. The fifth transistor M5 is turned off when an emission control signal is supplied to the emission control line EM and is turned on when the emission control signal is not supplied.

The first capacitor C1 is coupled between the first node N1 and the second node N2. The first capacitor C1 charges to a voltage level corresponding to the threshold voltage of the first transistor M1.

The second capacitor C2 is coupled between the second node N2 and the first power source ELVDD. The second capacitor C2 charges to a voltage level corresponding to the data signal.

FIG. 6 is a waveform chart illustrating a method of driving the pixel of FIG. 5.

Referring to FIG. 6, first the scan signal is supplied to the scan lines S1 to Sn for the reset period RP and the compensation period CP, and the emission control signal is supplied to the emission control line Em for the reset period RP, the compensation period CP, and the data period DP. In addition, the voltage of the reference power source Vref is supplied to the data lines D1 to Dm for the reset period RP, the compensation period CP, and the emission period EP, and the first control signal is supplied to the first control line CL1 for the reset period RP.

When the emission control signal is supplied to the emission control line EM, the fifth transistor M5 is turned off. When the fifth transistor M5 is turned off, the electrical connection between the OLED and the first transistor M1 is interrupted. Therefore, the pixels 140 are set to the non-emission state for the reset period RP, the compensation period CP, and the data period DP.

When the scan signal is supplied to the scan lines S1 to Sn, the third transistors M3 of the respective pixels 140 are turned on. Then, the voltage of the reference power source Vref is supplied to the respective second nodes N2 of the pixels 140 for the reset period RP and the compensation period CP.

When the first control signal is supplied to the first control line CL1, the fourth transistor M4 is turned on. When the fourth transistor M4 is turned on, the voltage (that is, the initial voltage) applied to the anode electrode of the OLED is supplied to the first node N1.

The second control signal is supplied to the second control line CL2 for the compensation period CP. When the second control signal is supplied to the second control line CL2, the second transistor M2 is turned on. When the second transistor M2 is turned on, the first transistor M1 is coupled in the form of a diode, e.g., diode-connecting the first transistor M1. At this time, since the first node N1 is initialized by the initial voltage, the first transistor M1 is turned on and the first node N1 is set to a voltage level equal to the threshold voltage of the first transistor M1 subtracted from the first power source ELVDD. At this time, the first capacitor C1 charges to a voltage corresponding to a voltage difference between the second node N2 and the first node N1. That is, the first capacitor C1 charges to a voltage level corresponding to the threshold voltage of the first transistor M1 for the compensation period CP.

The scan signal is sequentially supplied to the scan lines S1 to Sn for the data period DP and data signals are supplied to the data lines D1 to Dm in synchronization with the scan signal. When the scan signal is supplied to the scan line Sn, the third transistor M3 is turned on. When the third transistor M3 is turned on, the data signal is supplied from the data line Dm to the second node N2.

At this time, the second capacitor C2 charges a voltage corresponding to the data signal. On the other hand, since the first node N1 is at a floating state for the data period DP, the first capacitor C1 maintains the voltage charged for the previous period.

Change of the voltage of the first node N1 will be described in detail as follows. The second node N2 is set to the reference power source Vref for the compensation period CP and the first node N1 is set to a voltage of subtracting the threshold voltage of the first transistor M1 from the first power source ELVDD. After that, the second node N2 is changed into a voltage of the data signal from the reference power source Vref and the first node N1 is changed in response to the change of the voltage of the second node N2.

In a case where the pixels 140 display a black gray scale (e.g., a gray level or a gray scale level corresponds to black color), the data signal is set to a voltage higher than the reference power source Vref so that a voltage of the first node N1 is increased. Then, the first transistor M1 is turned off and a gray level corresponding to a black color is displayed. In addition, when the pixels 140 display a white color (e.g., a gray scale corresponding to a white color), the data signal is set to a voltage lower than the reference power source Vref so that a voltage of the first node N1 is decreased. Then, the amount of current supplied from the first transistor M1 to the OLED is controlled in response to a voltage of the white color applied to the first node N1. That is, in the present embodiment, a gray scale (e.g., a predetermined gray scale) is implemented using a voltage difference between the reference power source Vref and the data signal. In this case, an image of desired brightness may be displayed regardless of voltage drop of the first power source ELVDD.

Supply of the emission control signal to the emission control line EM is stopped for the emission period EP. When the supply of the emission control signal to the emission control line EM is stopped, the fifth transistor M5 is turned on. When the fifth transistor M5 is turned on, the first transistor M1 is electrically coupled to the OLED. At this time, the first transistor M1 controls the amount of current supplied to the OLED in response to (e.g., in accordance with) a voltage applied to the first node N1 such that the OLED emits light, e.g., of a desired brightness level.

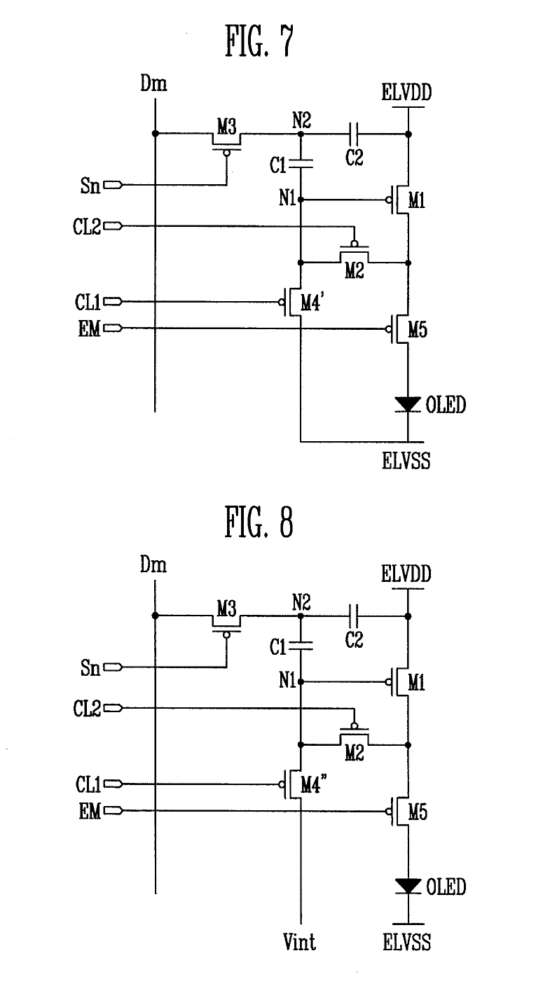

FIG. 7 is a view illustrating a second embodiment of the pixel of FIG. 4. With respect to FIG. 7, the same reference numerals refer to same elements as FIG. 5 and their description will be omitted.

Referring to FIG. 7, a first electrode of a fourth transistor M4′ is coupled to a first node N1 and a second electrode of the fourth transistor M4′ is coupled to a second power source ELVSS. A gate electrode of the fourth transistor M4′ is coupled to a first control line CL1. The fourth transistor M4′ is turned on when a first control signal is supplied to the first control line CL1, and supplies a voltage of the second power source ELVSS to the first node N1. That is, in the second embodiment of the present invention, the second power source ELVSS, as an initial voltage for initializing the gate electrode of the first transistor M1, is supplied. The remaining elements and operations are substantially similar to those of the pixel of FIG. 5 and their descriptions will be omitted.

FIG. 8 is a view illustrating a pixel according to a third embodiment of the present invention. With respect to FIG. 8, same reference numerals refer to the same elements as FIG. 5 and their description will be omitted.

Referring to FIG. 8, a first electrode of a fourth transistor M4″ is coupled to a first node N1 and a second electrode thereof is coupled to an initial power source Vint. A gate electrode of the fourth transistor M4″ is coupled to a first control line CL1. The fourth transistor M4″ is turned on when a first control signal is supplied to the first control line CL1 and supplies a voltage of the initial power source Vint to the first node N1. Here, the initial power source Vint is set to have a voltage lower than a first power source ELVDD. That is, in the third embodiment of the present invention, the initial power source Vint is added to initiate a gate electrode of a first transistor M1. The remaining elements and operation are substantially similar to those of the pixel of FIG. 5 and their description will be omitted.

FIG. 9 is a view illustrating a pixel according to a fourth embodiment of the present invention. With respect to FIG. 9, same reference numerals refer to the same elements of FIG. 5 and their description will be omitted.

Referring to FIG. 9, a first capacitor C1′ is coupled between a first node N1 and a second electrode of a third transistor M3 and a second capacitor C2′ is coupled between the first node N1 and a first power source ELVDD. The first capacitor C1′ charges a voltage corresponding to a threshold voltage of the first transistor M1 and the second capacitor C2′ charges a voltage corresponding to a data signal.

The operation of an embodiment according to the present invention will be described briefly with reference to FIGS. 6 and 9. A first control signal is supplied to a first control line CL1 for a reset period RP and a fourth transistor M4 is turned on.

When the fourth transistor M4 is turned on, a voltage (that is, an initial voltage) applied to an anode electrode of an OLED is supplied to the first node N1.

A second control signal is supplied to a second control line CI2 for a compensation period CP and a second transistor M2 is turned on. When the second transistor M2 is turned on, the first transistor M1 is coupled in the form of a diode (e.g., diode-connected) and a voltage of subtracting a threshold voltage of the first transistor M1 from the first power source ELVDD is supplied to the first node N1.

A voltage of a reference power source Vref is applied to a second electrode of a third transistor M3 for the compensation period CP. Therefore, the first capacitor C1 charges a voltage corresponding to the voltage of the reference power source Vref and a voltage applied to the first node N1, that is, a voltage corresponding to the threshold voltage of the first transistor M1 for the compensation period CP.

Scan signals are sequentially supplied to scan lines S1 to Sn for a data period DP and data signals are supplied to data lines D1 to Dm in synchronization with the scan signals. When a scan signal is supplied to the scan line Sn, the third transistor M3 is turned on and a voltage of the data signal is supplied to a first electrode of the first capacitor C1′. At this time, the voltage of the first electrode of the first capacitor C1′ is changed from the voltage of the reference power source Vref to the voltage of the data signal and a second electrode of the first capacitor C1′, that is, the first node N1 is changed in response to (e.g., in accordance with) the voltage change. At this time, the second capacitor C2′ charges a voltage corresponding to a voltage corresponding to (e.g., in accordance with) the difference between the first node N1 and the first power source ELVDD, that is, the data signal.

Supply of an emission control signal to an emission control line is stopped for an emission period EP and a fifth transistor M5 is turned on. At this time, the first transistor M1 controls the amount of current supplied to the OLED in response to (e.g., in accordance with) a voltage applied to the first node N1.

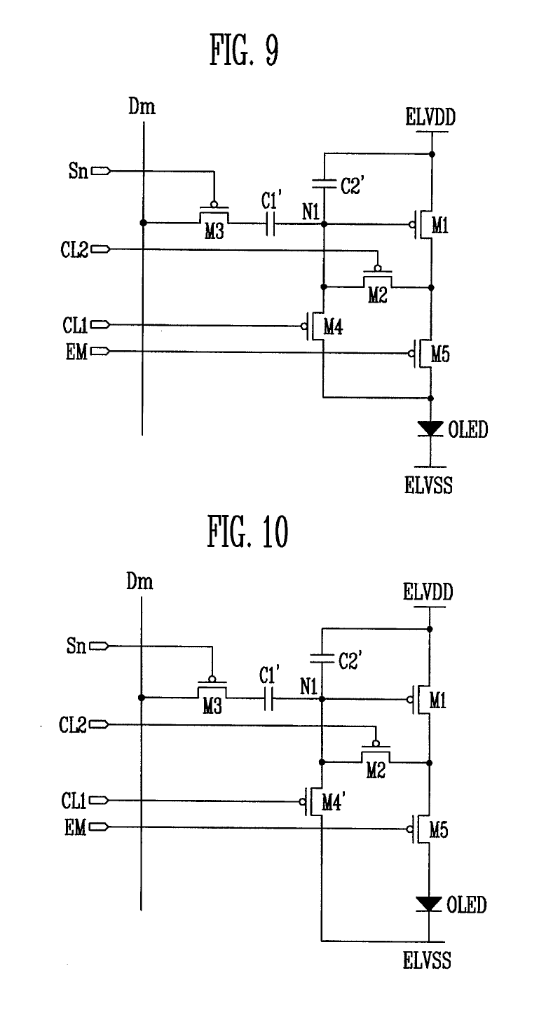

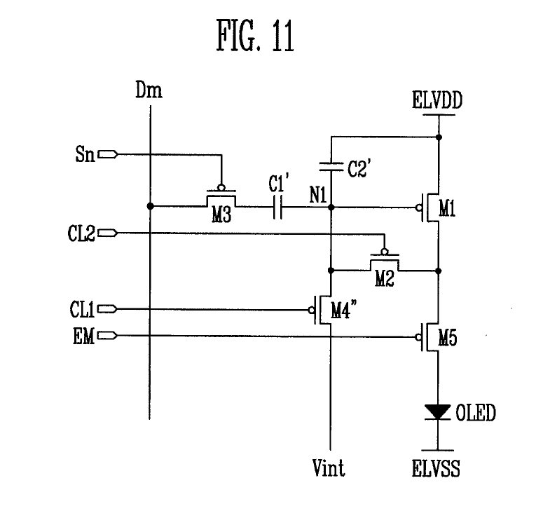

FIG. 10 is a view illustrating a pixel according to a fifth embodiment of the present invention. With respect to FIG. 10, the same reference numerals are assigned to substantially similar elements of FIG. 9 and their description will be omitted.

Referring to FIG. 10, a first electrode of a fourth transistor M4′ is coupled to a first node N1 and a second electrode of the fourth transistor M4′ is coupled to a second power source ELVSS. A gate electrode of the fourth transistor M4′ is coupled to a first control line CL1. The fourth transistor M4′ is turned on when a first control signal is supplied to the first control line CL1 and supplies a voltage of the second power source ELVSS to the first node N1. That is, in the fifth embodiment of the present invention, the second power source ELVSS as an initial voltage for initializing the gate electrode of the first transistor M1 is supplied. The rest elements and operation are substantially similar to those of the pixel of FIG. 9, and description will be omitted.

FIG. 11 is a view illustrating a pixel according to a sixth embodiment of the present invention. With respect to FIG. 11, the same reference numerals are assigned to substantially similar elements of FIG. 9, and their description will be omitted.

Referring to FIG. 11, a first electrode of a fourth transistor M4″ is coupled to a first node N1 and a second electrode of the fourth transistor M4″ is coupled to an initial power source Vint. A gate electrode of the fourth transistor M4″ is coupled to a first control line CL1. The fourth transistor M4″ is turned on when a first control signal is supplied to the first control line CL1 and supplies a voltage of the initial power source Vint to the first node N1. Here, the initial power source Vint is set to a voltage lower than that of a first power source ELVDD. That is, in the sixth embodiment of the present invention, the initial power source Vint is added to initiate a gate electrode of a first transistor M1. The rest elements and operation are substantially similar to those of the pixel of FIG. 9 and description will be omitted.

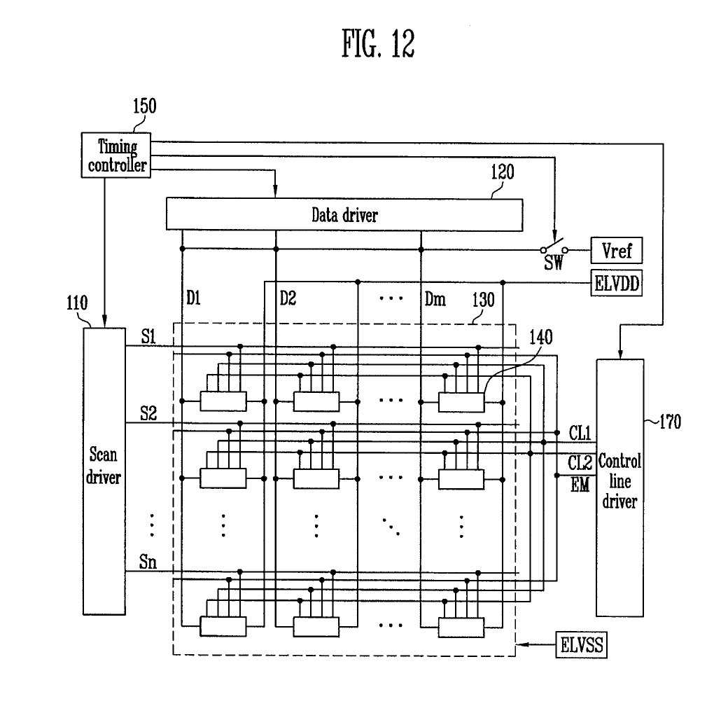

FIG. 12 is a view illustrating an organic light emitting display device according to an embodiment of the present invention. With respect to FIG. 12, same reference numerals are assigned to substantially similar elements of FIG. 4 and their description will be omitted.

Referring to FIG. 12, the organic light emitting display device according to the present embodiment of the present invention includes a switching device SW coupled between respective data lines D1 to Dm and a reference power source Vref. The switching device SW is turned on in response to the control of a timing controller 150 for a reset period RP, a compensation period Cp, and an emission period EP. Then, the reference power source Vref is supplied to the data lines D1 to Dm for the reset period RP, the compensation period CP, and the emission period EP.

In comparison to the organic light emitting display device of FIG. 4, in the organic light emitting display device of FIG. 4, the data driver 120 supplies a voltage of the reference power source Vref to the data lines D1 to Dm for the reset period RP, the compensation period CP, and the emission period EP. However, in the present embodiment of the present invention, the switching device SW is added to the outside of the data driver 120 to supply the voltage of the reference power source Vref to the data lines D1 to Dm. As such, when the switching device SW is added, the structure of the data driver 120 is not changed so that fabricating costs can be reduced and the voltage of the reference power source Vref can be freely adjusted.

FIG. 13 is a graph illustrating current corresponding to a data voltage in a pixel according to a third embodiment of the present invention.

Referring to FIG. 13, when a voltage of a data signal is changed from 3V to 13V, current flowing through the OLED is also changed. In the present invention, a voltage range of the data signal is set to wider and an image having desired gray scale (e.g., gray level or gray scale level) can be displayed more precisely.

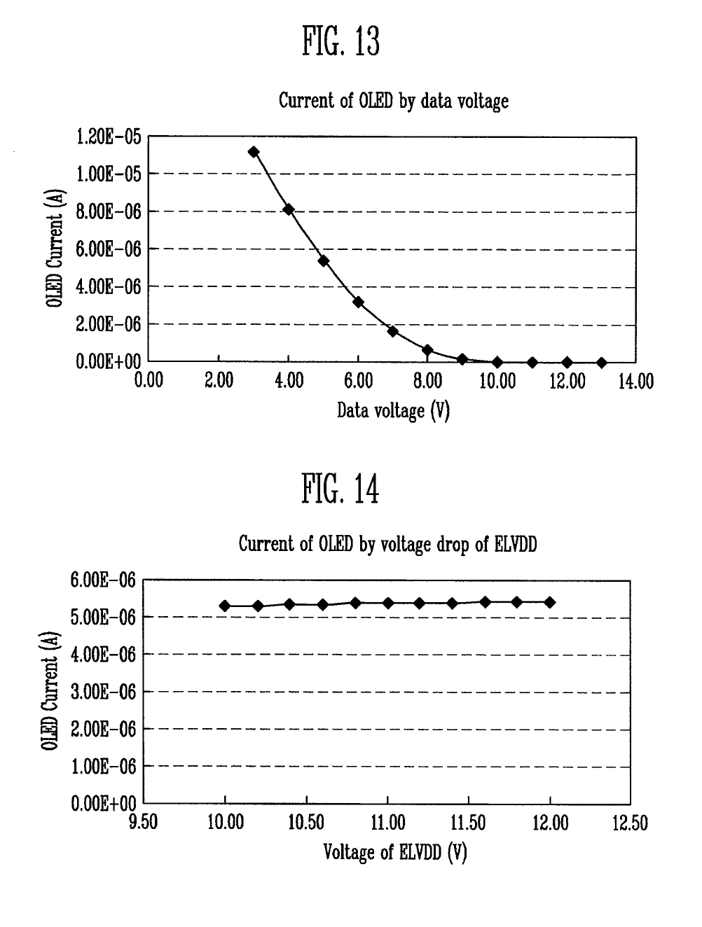

FIG. 14 is a graph illustrating change of current corresponding to voltage drop of the first power source in the pixel according to a third embodiment of the present invention.

Referring to FIG. 14, when the voltage of the first power source ELVDD is changed within a range of 10V to 12V, current flowing through the OLED is hardly changed. Since a voltage applied to the gate electrode of the first transistor M1 is determined by the reference power source Vref and the data signal in the present invention, a desired current can be supplied to the OLED regardless of voltage drop of the first power source ELVDD.

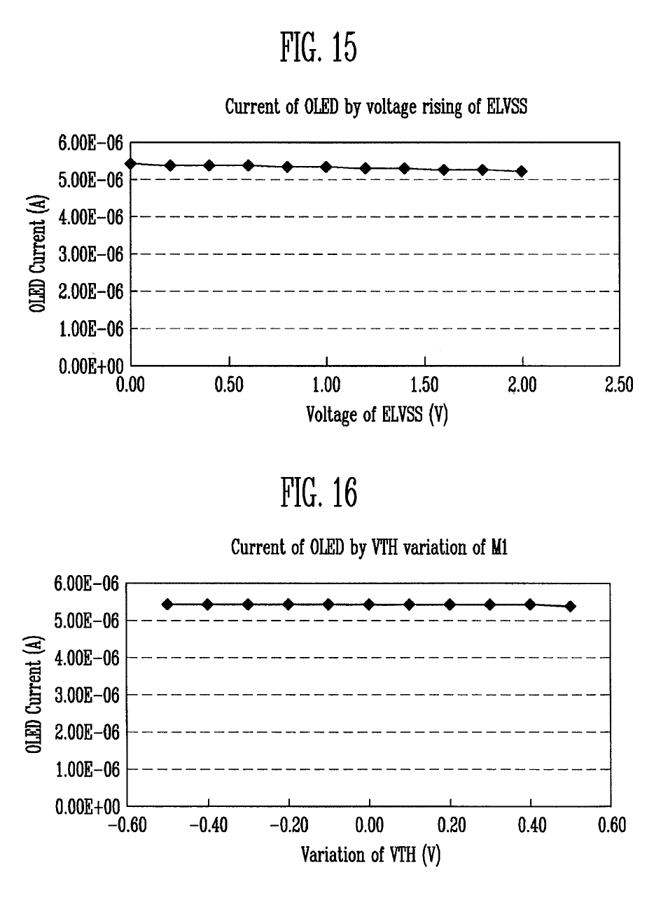

FIG. 15 is a graph illustrating change of current corresponding to change of a voltage of the second power source in the pixel according to the third embodiment of the present invention.

Referring to FIG. 15, when a voltage of the second power source ELVSS is changed from 0V to 2V, current flowing through the OLED is hardly changed. Therefore, a desired current can be supplied to the OLED regardless of change of voltage of the second power source ELVSS.

FIG. 16 is a graph illustrating change of current corresponding to change of the threshold voltage of the first transistor in the pixel according to the third embodiment of the present invention.

Referring to FIG. 16, when the threshold voltage of the first transistor M1 is changed from −0.5V to 0.5V, current flowing through the OLED is hardly changed. Therefore, a desired current can be supplied to the OLED regardless of the change of the threshold voltage of the first transistor M1.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An organic light emitting display having a frame period comprising a reset period, a compensation period, a data period, and an emission period, the organic light emitting display device comprising:
pixels positioned at crossing regions scan lines and data lines;
a first control line and a second control line commonly coupled to the pixels; and
a control line driver for supplying a first control signal to the first control line for the reset period, and for supplying a second control signal to the second control line for the compensation period,
wherein each of the pixels comprises:
an organic light emitting diode;
a first transistor having a first electrode, a second electrode, and a gate electrode, the first transistor being configured to control an amount of current supplied from a first power source coupled to the first electrode to a second power source via the organic light emitting diode;
a second transistor coupled between the gate electrode of the first transistor and the second electrode of the first transistor and configured to turn on when the second control signal is supplied; and
a fourth transistor coupled to the gate electrode of the first transistor and configured to supply an initial voltage to the gate electrode of the first transistor when the first control signal is supplied.

2. The organic light emitting display as claimed in claim 1, wherein the pixels are set to a non-emission state for the reset period, the compensation period, and the data period.

3. The organic light emitting display device as claimed in claim 1, further comprising:
a scan driver configured to concurrently supply a first scan signal to the scan lines for the reset period and the compensation period and to sequentially supply a second scan signal to the scan lines for the data period; and
a data driver configured to supply a data signal to the data lines in synchronization with the second scan signal during the data period.

4. The organic light emitting display device as claimed in claim 3, further comprising an emission control line commonly coupled to the pixels.

5. The organic light emitting display device as claimed in claim 4, wherein the control line driver is configured to supply an emission control signal to the emission control line for the reset period, the compensation period, and the data period.

6. The organic light emitting display device as claimed in claim 5, wherein each of the pixels comprises:
a first capacitor coupled between the gate electrode of the first transistor and a second node;
a third transistor coupled between the data lines and the second node and configured to be turned on when a first scan signal and a second scan signal are supplied to the scan lines;
a second capacitor coupled between the second node and the first power source; and
a fifth transistor coupled between the second electrode of the first transistor and the organic light emitting diode, the fifth transistor being configured to be turned off when an emission control signal is supplied to the emission control line, and to be turned on otherwise.

7. The organic light emitting display device as claimed in claim 5, wherein each of the pixels comprises:
a first capacitor coupled between the gate electrode of the first transistor and the data lines;
a third transistor coupled between the first capacitor and the data lines and configured to be turned on when a first scan signal and a second scan signal are supplied to the scan lines;
a second capacitor coupled between the gate electrode of the first transistor and the first power source; and
a fifth transistor coupled between the second electrode of the first transistor and the organic light emitting diode, the fifth transistor being configured to be turned off when an emission control signal is supplied to the emission control line, and turned on otherwise.

8. The organic light emitting display device as claimed in claim 3, wherein the data driver is configured to supply a voltage of a reference power source to the data lines for the reset period, the compensation period, and the emission period.

9. The organic light emitting display device as claimed in claim 8, wherein a voltage of the reference power source is a voltage within a voltage range of the data signals.

10. The organic light emitting display device as claimed in claim 3, further comprising a switching device coupled between each of the data lines and the reference power source and turned on for the reset period, the compensation period, and the emission period.

11. The organic light emitting display device as claimed in claim 10, wherein the voltage of the reference power source is a voltage within a voltage range of the data signals.

12. The organic light emitting display device as claimed in claim 1, wherein the initial voltage is set to a voltage lower than the first power source.

13. The organic light emitting display device as claimed in claim 12, wherein the fourth transistor is configured to supply a voltage applied to an anode electrode of the organic light emitting diode as the initial voltage.

14. The organic light emitting display device as claimed in claim 12, wherein the fourth transistor is configured to supply a voltage of the second power source as the initial voltage.

15. The organic light emitting display as claimed in claim 12, wherein the fourth transistor is electrically coupled to an initial power source for supplying the initial voltage.

16. A method of driving an organic light emitting display device having a frame period comprising a reset period, a compensation period, a data period, and an emission period, the method comprising:
initializing gate electrodes of driving transistors included in respective pixels to an initial voltage for the reset period;
charging first capacitors of the respective pixels to a voltage corresponding to a threshold voltage of the driving transistors for the compensation period while diode-connecting the driving transistors;
charging second capacitors of the respective pixels to a voltage corresponding to data signals by supplying the data signals to the pixels for the data period; and
controlling an amount of current supplied from a first power source to an organic light emitting diode in response to a voltage applied to gate electrodes of the driving transistors for the emission period.

17. The method as claimed in claim 16, wherein the initial voltage is set to a voltage lower than a voltage of the first power source.

18. The method as claimed in claim 16, wherein the pixels are set to a non-emission state for the reset period, the compensation period, and the data period.
